(19) United States
(12) Patent Application Publication
(10) Pub. No.: US 2003/0083409 A1
(43) Pub. Date: May 1, 2003

(54) Flame-resistant polyester molding compositions with polyolefin additives

(76) Inventors: Matthias Bienmuller, Krefeld (DE); Michael Wagner, Moers (DE)

Correspondence Address: BAYER CORPORATION, PATENT DEPARTMENT, 100 BAYER ROAD, PITTSBURGH, PA, 15205, US

(21) Appl. No.: 10/178,925

(22) Filed: Jun. 24, 2002

(30) Foreign Application Priority Data
Jun. 27, 2001 (DE) 10130832.9

(51) Int. Cl. C08K 5/52; C08K 3/30; C08K 5/01

(52) U.S. Cl. 524/127; 524/487; 524/420

(57) ABSTRACT

A flame-resistant thermoplastic molding compositions containing one or more polyesters is disclosed. In addition to the flame retardant agent that contains a phosphorus-containing compound and a nitrogen-containing compound, the composition also contains a polyolefin compound and an optional zinc sulphide. Also disclosed is the use of the molding composition for making molded articles, films and fibers.

The invention relates to thermoplastic molding compositions and more particularly to flame retardant compositions containing a polyolefin and a phosphorus compound.

A flame-resistant thermoplastic molding compositions containing one or more polyesters is disclosed. In addition to the flame retardant agent that contains a phosphorus-containing compound and a nitrogen-containing compound, the composition also contains a polyolefin compound and an optional zinc sulphide. Also disclosed is the use of the molding composition for making molded articles, films and fibers.

Flame-proofed polyester molding compositions are of great importance in the electrical/electronic field, where they are used inter alia for making supports for live parts. The components need to have good mechanical and electrical resistance as well as good flame resistance. A particular requirement is the preparation of halogen-free molding compositions. There have been some developments in this field in the past.

Thus JP-A 3-281 652 discloses polyalkylene terephthalate resins containing a melamine cyanuric acid adduct and a phosphate or phosphonate and additional filling material as a flame retardant. JP-A 6-157880 discloses reinforced polyalkylene terephthalates containing melamine cyanurate and a phosphorus compound as a flame retardant. JP-A 9-157 503 discloses flame-retardant polyester compositions containing melamine cyanurate, phosphoric acid ester and special mold release agents. Flame-retardant, reinforced polyester components containing a combination of melamine pyrophosphate and a phosphate oligomer are known from EP-A 903 370. WO 00/11085 discloses polyester molding compositions containing melamine cyanurate, a phosphate, filler and special mold release agents. WO 00/11071 discloses polyester compositions containing nitrogen compounds, phosphorus compounds, metal salts and stabilizer.

Yet there is still a great need for halogen-free, flame-resistant polyester molding compositions which have improved mechanical properties, such as impact strength and outer fiber elongation in particular, as well as good flame resistance.

It has now been found, surprisingly, that polyester molding compositions containing a combination of a phosphorus-containing compound and a nitrogen-containing compound as well as a polyolefin compound and possibly zinc sulphide as a flame retardant have the desired properties. The additional use of zinc sulphide has been found to give a further improvement in the mechanical properties of the molding compositions.

The subject of the invention is thus molding compositions containing:

A) one or more polyesters

B) 10 to 40% by weight, preferably 15 to 26% and particularly preferably 18 to 23% of a flame retardant component containing:

B.1) one or more nitrogen compounds and

B.2) a phosphorus compound of formula (I)

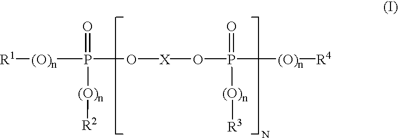

where

R¹, R², R³ and R⁴ each mean, independently of one another, C₁ to C₈ alkyl which is optionally halogenated or C₅ to C₆ cycloalkyl, C₆ to C₂₀ aryl or C₇ to C₁₂ aralkyl which are each optionally alkyl-, preferably C₁ to C₄ alkyl-substituted and/or halogen-, preferably chlorine or bromine-substituted, very preferred phenyl

n is 0 or 1, independently of each other; preferably 1

m is 0 to 50, preferably an average value from 0 to 20 and particularly preferably 0 to 10, especially 0 to 6

X is an aromatic radical with single or multiple rings and with 6 to 30 C atoms derived from diphenols, preferably diphenyl phenol, bisphenol A, resorcinol or hydroquinone and their chlorinated or brominated derivatives,

C) 0.05 to 1.5% by weight, preferably 0.1 to 0.7% and particularly preferably 0.15 to 0.45% polyolefin wax,

D) 0 to 5% by weight, preferably 0 to 4% and particularly preferably 0 to 3.5% zinc sulphide and

E) 0 to 50% by weight, preferably 10 to 40% and particularly preferably 10 to 35% of one or more fillers and reinforcing agents,

F) is 0 to 40% relative to the total weight of the composition of further additives,

the sum of the content of the components making up 100% by weight.

The polyesters of component A) include polyalkylene terephthalates, i.e. reaction products of preferably aromatic dicarboxylic acids or reactable derivatives thereof (for example dimethyl esters or anhydrides) and aliphatic, cycloaliphatic or araliphatic diols and mixtures of those reaction products, and secondly completely aromatic polyesters, which will be described in more detail later.

Polyalkylene terephthalates may be prepared by known methods from terephthalic acid (or reactable derivatives thereof) and aliphatic or cycloaliphatic diols with 2 to 10 C atoms (Kunststoff-Handbuch, vol. VIII, pp. 695 ff., Karl-Hanser-Verlag, Munich 1973).

Preferred polyalkylene terephthalates contain at least 80 and preferably 90 molar % terephthalic acid radicals relative to the dicarboxylic acid, and at least 80, preferably at least 90 molar % ethylene glycol- and/or propane diol-1,3- and/or butane diol-1,4 radicals relative to the diol component.

In addition to terephthalic acid radicals, the preferred polyalkylene terephthalates may contain up to 20 molar % of radicals of other aromatic dicarboxylic acids with 8 to 14 C atoms or aliphatic dicarboxylic acids with 4 to 12 C atoms, such as radicals of phthalic acid, isophthalic acid, naphthalene-2,6-dicarboxylic acid, 4,4′-diphenyl dicarboxylic acid, succinic, adipinic, sebacic, azelaic or cyclohexane diacetic acid.

As well as ethylene and/or propane diol-1,3 and/or butane diol-1,4-glycol radicals, the preferred polyalkylene terephthalates may contain up to 20 molar % of other aliphatic diols with 3 to 12 C atoms or cycloaliphatic diols with 6 to 21 C atoms, for example radicals of propanediol-1,3, 2-ethylpropane diol-1,3, neopentylglycol, pentanediol-1,5, hexanediol-1,6, cyclohexane-dimethanol-1,4, 3-methylpentanediol-2,4, 2-methylpentanediol-2,4, 2,2,4-trimethylpentanediol-1,3 and 1,6,2-ethyl hexane-diol-1,3, 2,2-diethyl propanediol-1,3, hexanediol-2,5, 1,4-di-(β-hydroxyethoxy)-benzene, 2,2-bis-(4-hydroxycyclohexyl)-propane, 2,4-dihydroxy-1,1,3,3-tetramethyl cyclobutane, 2,2-bis-(3-β-hydroxyethoxyphenyl)-propane and 2,2-bis-(4-hydroxy-propoxyphenyl)-propane (DE-OS 24 07 674, 24 07 776, 27 15 932).

The polyalkylene terephthalates may be branched by incorporating relatively small quantities of tri or tetrahydric alcohols or tri or tetrabasic carboxylic acids, as described for example in DE-OS 19 00 270 and U.S. Pat. No. 3,692,744. Some examples of preferred side chain forming agents are trimesic acid, trimellitic acid, trimethylene ethane and propane and pentaerythrite.

It is advisable to use no more than 1 molar % of side chain forming agent relative to the acid component.

Particularly preferred polyalkylene terephthalates are those prepared solely from terephthalic acid and reactable derivatives thereof (for example dialkylesters thereof) and ethylene glycol and/or propanediol-1,3 and/or butanediol-1,4 (polyethylene, polypropylene and polybutylene terephthalate) and mixtures of those polyalkylene terephthalates. In the invention, mixtures of polybutylene and polyethylene terephthalate is very specially preferred.

Other preferred polyalkylene terephtyhalates are copolyesters prepared from at least two of the above-mentioned acid components and/or at least two of the above-mentioned alcohol components; the particularly preferred copolyesters are poly-(ethylene glycol/butanediol-1,4)-terephthalates.

Polyalkylene terephthalates generally have an intrinsic viscosity of approx. 0.4 to 1.5, preferably 0.5 to 1.3, in each case measured in phenol/o-dichlorobenzene (1:1 parts by weight) at 25° C.

Completely aromatic polyesters which are also suitable are reaction products of aromatic dicarboxylic acids or reactive derivatives thereof and corresponding aromatic dihydroxy compounds.

The aromatic dicarboxylic acids used may be the compounds already discussed when describing the polyalkylene terephthalates. Mixtures of 5 to 100 molar % isophthalic acid and 0 to 95 molar % terephthalic acid are preferred, particularly mixtures of approx. 80% terephthalic acid with 20% isophthalic acid to approximately equivalent mixtures of these two acids.

Aromatic dihydroxy compounds which are also used may be described by the following formula (II)

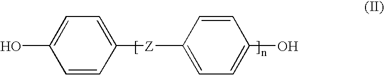

where

Z stands for an alkylene or cycloalkylene group with up to 8 carbon atoms, an arylene group with up to 12 carbon atoms, a carbonyl group, an oxygen or sulphur atom, a sulphonyl group or a chemical bond and

n has a value of 0 to 2.

The compounds may each carry C₁to C₆-alkyl or alkoxy groups on the phenylene units and fluorine, chlorine or bromine as substituents.

The following may be mentioned as representatives of these substances: dihydroxy-phenyl, di-(hydroxyphenyl)alkane, di-(hydroxyphenyl)cycloalkane, di-(hydroxy-phenyl)sulphide, di-(hydroxyphenyl)ether, di-(hydroxphenyl)ketone, di-(hydroxy-phenyl)sulphoxide, di-(hydroxyphenyl), α,α′-di-(hydroxyphenyl)-dialkylbenzene, di-(hydroxyphenyl)sulphone, di-(hydroxybenzoyl)benzene, resorcinol, hydroquinone and derivatives thereof with alkylated or halogenated rings.

Of the above-mentioned group, 4,4′-dihydroxydiphenyl, 2,4-di-(4′-hydroxyphenyl)-2-methylbutane, α,α-di-(4-hydroxyphenyl)-p-diisopropylbenzene, 2,2-di-(3′-meth-yl-4′-hydroxyphenyl)propane and 2,2-di-(3′-chloro-4′-hydroxyphenyl)propane are preferred.

The following are particularly preferred: 2,2-di-(3′, 5′-dimethyl-4′-hydroxyphenyl)-propane, 2,2-di-(4′-hydroxyphenyl)propane, 4,4′-dihydroxydiphenylsulphone, 2,2-di-(3′,5-dichlorodihydroxyphenyl)propane, 1,1-di-(4′-hydroxyphenyl)cyclohexane and 3,4′-dihydroxybenzophenone.

Mixtures of said diol compounds may also be used.

Apart from using pure polyalkylene terephthalates and pure completely aromatic polyesters, any mixtures thereof and of the following polyesters may also be employed.

“Polyesters” are understood as including polycarbonates, copolycarbonates (that is (co)polycarbonates), polyesters and copolyesters, that is (co)polyesters) and polyester carbonates.

Polycarbonates and polyester carbonates are known from the literature or may be prepared by methods known from the literature (for the preparation of polycarbonates see for example Schnell, “Chemistry and Physics of Polycarbonates”, Interscience Publishers, 1964 and DE-A 1 495 626, DE-A 2 232 877, DE-A 2 703 376, DE-A 2 714 544, DE-A 3 000 610, DE-A 3 832 396; for the preparation of polyester carbonates see for example DE-A 3 077 934).

Aromatic polycarbonates are prepared for example by reacting diphenols with carbonic acid halides, preferably phosgene and/or with aromatic dicarboxylic acid dihalides, preferably benzene dicarboxylic acid dihalides, by the phase boundary method, possibly using chain terminators such as monophenols and possibly using trifunctional or more than trifunctional side chain forming agents such as triphenols or tetraphenols.

Diphenols for preparing aromatic polycarbonates and/or aromatic polyester carbonates are preferably those of formula (III)

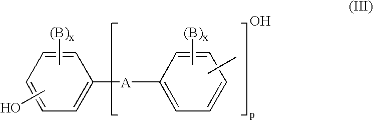

where

A represents a single bond, C₁-C₅ alkylene, C₂-C₅ alkylidene, C₅-C₆ cyclo-alkylidene, —O—, —SO—, —CO—, —S—, —SO₂—, C₆-C₁₂ arylene onto which further aromatic rings, possibly containing heteroatoms, may be condensed, or a radical of formula (IV) or (V)

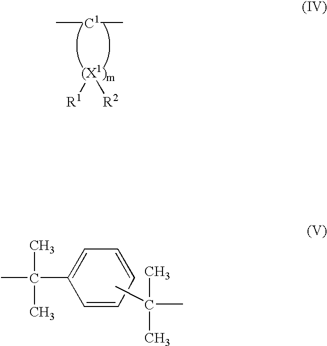

B in each case represents C₁-C₁₂ alkyl, preferably methyl or halogen, preferably chlorine and/or bromine,

x in each case, independently of one another, is 0.1 or 2,

p is 1 or 0 and

R¹ and R², individually selectable for each X¹ and independent of one another, are hydrogen or C₁-C₆ alkyl, preferably hydrogen, methyl or ethyl,

X¹ is carbon and

m is a whole number from 4 to 7, preferably 4 or 5, with the proviso that on at least one X¹ atom R¹ and R² are simultaneously alkyl.

Preferred diphenols are hydroquinone, resorcinol, dihydroxydiphenols, bis-(hy-droxyphenyl)-C₁-C₅ alkanes, bis-(hydroxyphenyl)-C₅-C₆-cycloalkanes, bis-(hydroxy-phenyl)ethers, bis-(hydroxyphenyl)sulphoxides, bis-(hydroxphenyl)-ketones, bis-(hydroxyphenyl)sulphones and α,α-bis-(hydroxyphenyl)-diisopropyl benzenes and derivatives thereof with brominated and/or chlorinated rings.

Particularly preferred diphenols are 4,4′-dihydroxydiphenyl, bisphenol-A, 2,4-bis(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenylsulphide, 4,4′-dihydroxydiphenyl-sulphone and their di and tetrabrominated or chlorinated derivatives such as 2,2-bis(3-chloro-4-hydroxyphenyl)propane, 2,2-bis-(3,5-dichloro-4-hydroxyphenyl)propane or 2,2-bis-(3,5-dibromo-4-hydroxyphenyl)-propane.

2,2-bis-(4-hydroxyphenyl)propane (bisphenol-A) is particularly preferred.

The diphenols may be used singly or in any mixtures. They are known from the literature or obtainable by methods known from the literature.

Suitable chain terminators for the production of the thermoplastic, aromatic poly-carbonates are for example phenol, p-chlorophenol, p-tert.-butylphenol or 2,4,6-tribromophenol, but also long-chain alkylphenols, such as 4-(1,3-tetramethyl-butyl)phenol in accordance with DE-A 2 842 005 or monoalkylphenol or dialkyl-phenols with a total or 8 to 20 carbon atoms in the alkyl substituents, such as 3,5-di-tert-butylphenol, p-iso-octylphenol, p-tert.-octylphenol, p-dodecylphenol and 2-(3,5-dimethylheptyl)-phenol and 4-(3,5-dimethylheptyl)-phenol. The quantity of chain terminators to be used is generally between 0.5 and 10 molar % relative to the molar total of diphenols used.

The thermoplastic, aromatic polycarbonates have mean weight-average molecular weights (M_{w}, measured for example by an ultracentrifuge or scattered light measurement) of 10,000 to 200,000, preferably 20,000 to 80,000.

The thermoplastic, aromatic polycarbonates may be branched in a known manner, preferably by incorporating 0.05 to 2.0 molar %, relative to the sum of diphenols used, of trifunctional or more than trifunctional compounds, for example compounds with three or more phenolic groups.

Both homopolycarbonates and copolycarbonates are suitable. To produce copolycarbonates according to the invention, 1 to 25% by weight, preferably 2.5 to 25% (relative to the total quantity of diphenols used) polydiorganosiloxanes with hydroxy-aryloxy end groups may be employed. These are known (see for example U.S. Pat. No. 3,419,634) or obtainable by methods known from the literature. The preparation of polydiorganosiloxane-containing copolycarbonates is described for example in DE-A 3 334 782.

The polycarbonates which are preferred as well as the bisphenol-A-homopoly-carbonates are copolycarbonates of bisphenol-A with up to 15 molar %, relative to the molar total of diphenols, of diphenols other than those mentioned as being preferred or particularly preferred, especially 2,2-bis(3,5-dibromo-4-hydroxyphenyl)-propane.

Some examples of aromatic dicarboxylic acid dihalides for the preparation of aromatic polyester carbonates are diacid-dichlorides of isophthalic acid, terephthalic acid, diphenylether-4,4′-dicarboxylic acid and naphthalene-2,6-dicarboxylic acid.

Mixtures of diacid-dichlorides of isophthalic acid and terephthalic acid in a ratio between 1:20 and 20:1 are particularly preferred.

In the preparation of polyester carbonates a carbonic acid halide, preferably phosgene, is additionally used at the same time as a bifunctional acid derivative. Chain terminators which may be considered for preparing the aromatic polyester carbonates, apart from the monophenols already mentioned, include chlorocarbonic acid esters thereof and acid chlorides of aromatic monocarboxylic acids, possibly substituted by C₁-C₂₂ alkyl groups or by halogen atoms, and aliphatic C₂-C₂₂ monocarboxylic acid chlorides.

The quantity of chain terminators is 0.1 to 10 molar %, relative to mols of diphenols in the case of phenolic chain terminators and relative to mols of dicarboxylic acid dichlorides in the case of monocarboxylic acid chloride ones.

The aromatic polyester carbonates may also contain aromatic hydroxycarboxylic acids as modules.

The aromatic polyester carbonates may be both linear and branched in a known manner (see also DE-A 2 940 024 and DE-A 3 007 934). The side chain forming agents may for example be tri or polyfunctional carboxylic acid chlorides, such as trimesic acid trichloride, cyanuric acid trichloride, 3,3′-4,4′-benzophenone-tetra-carboxylic acid tetrachloride, 1,4,5,8-naphthalene tetracarboxylic acid tetrachloride or pyromellitic acid tetrachloride, in quantities of 0.01 to 1.0 molar % (relative to the dicarboxylic acid dichlorides used) or tri or polyfunctional phenols, such as phloroglucine, 4,6-dimethyl-2,4,6-tri-(4-hydroxyphenyl)heptene, 2,4,4-dimethyl-2,4-6-tri-(4-hydroxyphenyl)heptane, 1,3,5-tri-(4-hydroxyphenyl)benzene, 1,1,1-tri-(4-hydroxyphenyl)ethane, tri-(4-hydroxyphenyl)phenylmethane, 2,2-bis[4,4-bis(4-hydroxyphenyl)-cyclohexyl]propane, 2,4-bis(4-hydroxyphenyl-isopropyl)-phenol, tetra-(4-hydroxyphenyl)-methane, 2,6-bis(2-hydroxy-5-methyl-benzyl)-4-methyl-phenol, 2-(4-hydroxyphenyl)-2-(2,4-dihydroxyphenyl)-propane, tetra-(4-[4-hydroxyphenyl-isopropyl]-phenoxy)-methane, 1,4-bis[4,4′-dihydroxytriphenyl)-methyl]-benzene, in quantities of 0.01 to 1.0 molar % relative to the diphenols used. Phenolic side chain forming agents may be put in first with the diphenols, while acid chloride side chain forming agents may be introduced together with the acid dichlorides.

The proportion of carbonate structural groups in the thermoplastic aromatic polyester carbonates may be varied as desired. The proportion of carbonate groups is preferably up to 100 molar %, particularly up to 80 molar % and particularly preferably up to 50 molar %, relative to the total of ester groups and carbonate groups. Both the ester and the carbonate content of the aromatic polyester carbonates may be in the form of blocks or statistically distributed in the polycondensate.

The relative solution viscosity (ηᵣₑₗ) of the aromatic polycarbonates and polyester carbonates is in the range from 1.18 to 1.4, preferably 1.22 to 1.3 (measured on solutions of 0.5 g polycarbonate or polyester carbonate in 100 ml methylene chloride solution at 25° C.).

The thermoplastic aromatic polycarbonates and polyester carbonates may be used alone or mixed together in any way.

Any known polyester block copolymers such as copolyether esters may additionally be used, as described in U.S. Pat. No. 3,651,014.

Component B) is added to flameproof the polyester molding composition, component B) being a mixture of a nitrogen compound B.1 and a phosphorus compound B.2, together in a proportion of 10 to 40% by weight, preferably 15 to 26% and particularly preferably 18 to 23% relative to the entire molding composition. The best results have been obtained when 18 to 23% by weight of the flameproofing mixture consisted of nitrogen-containing and phosphorus-containing compounds. The proportion of nitrogen-containing compound B.1 is preferably 7 to 13% by weight, particularly preferably 9 to 11% relative to the molding composition. The proportion of phosphorus-containing compound B.2 is preferably 8 to 13% by weight, particularly preferably 9 to 12%, again relative to the molding composition. Suitable nitrogen compounds B.1 are melamine cyanurate, melamine, melamine borate, melamine oxalate, primary melamine phosphate, secondary melamine phosphate and secondary melamine pyrophosphate, polymeric melamine phosphate and neopentylglycol boric acid melamine. Guanidine salts are also suitable, such as guanidine carbonate, primary guanidine cyanurate, primary guanidine phosphate, secondary guanidine phosphate, primary guanidine sulphate, secondary guanidine sulphate, pentaerythrite boric acid guanidine, neopentylglycol boric acid guanidine, urea phosphate green and urea cyanurate. Condensed N-containing compounds meleme and melone may also be used. Ammonium polyphosphate and tris-(hydrocyethyl)isocyanurate are also suitable or reaction products of the latter with carboxylic acids, benzoguanamine and its adducts or salts, also its products substituted at the nitrogen position and their salts and adducts. Other possible nitrogen-containing components are allantoin compounds, their salts with phosphoric, boric or pyrophosphoric acid and glycoluriles or salts thereof. Inorganic nitrogen-containing compounds such as ammonium salts may also be used. The melamine compounds are preferred.

The nitrogen compound very particularly preferred for the invention, melamine cyanurate, is understood as being the reaction product of preferably equimolar quantities of melamine and cyanuric or isocyanuric acid. All commercial product qualities are included inter alia. Some examples are inter alia Melapur® MC 25 (DSM Melapur, Heerlen, Holland) and Budit® 315 (Budenheim, Budenheim, Germany). The melamine cyanurate used consists of particles with mean diameters of 0.1 to 100 μm, preferably 0.1 to 25 μm, particularly preferably 0.1 to 7 μm and may be surface treated and/or coated with known media. These include inter alia organic compounds which may be applied to the melamine cyanurate in monomeric, oligomeric and/or polymeric form. For example, coating systems based on silicon-containing compounds such as organo-functionalised silanes or organosiloxanes may be used. Coatings with inorganic components are also possible.

Melamine cyanurate is normally obtained from the starting materials in an aqueous medium at temperatures between 90 and 100° C.

The phosphorus compounds B.2) used in the flame retardant are phosphates of general formula (I)

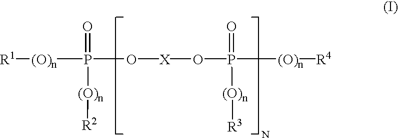

where

R¹, R², R³ and R⁴ each represent, independently of one another, C₁ to C₈ alkyl which is optionally halogenated or C₅ to C₆ cycloalkyl, C₆ to C₂₀ aryl or C₇ to C₁₂ aralkyl which are each optionally alkyl-, preferably C₁-C₄ alkyl-substituted and/or halogen-, preferably chlorine or bromine-substituted, very preferred phenyl

n is 0 or 1, independently of each other

m is 0 to 50, preferably 0 to 20 and particularly preferably 0 to 10, especially 0 to 6

X is an aromatic radical with single or multiple rings and with 6 to 30 C atoms derived from diphenols, preferably diphenylphenol, bisphenol A, resorcinol or hydroquinone and their chlorinated or brominated derivatives.

R¹, R², R³ and R⁴ preferably stand for C₁-C₄ alkyl, phenyl, naphthyl or phenyl-C₁-C₄ alkyl, independently of one another. The aromatic groups R¹, R², R³ and R⁴ may themselves be substituted by halogen and/or alkyl groups, preferably chlorine, bromine and/or C₁-C₄ alkyl. Particularly preferred aryl radicals are cresyl, phenyl, xylenyl, propylphenyl or butylphenyl.

The monophosphorus compounds of formula (I) are in particular tributyl phosphate, tris-(2-chloroethyl)-phosphate, tris-(2,3-dibromoprobyl)-phosphate, triphenyl phosphate, tricresyl phosphate, diphenyleresyl phosphate, diphenyloctyl phosphate, diphenyl-2-ethylcresyl phosphate, tri-(isopropylphenyl)-phosphate, halogen-substituted aryl phosphates, methyl phosphonic acid dimethyl ester, methylphosphenic acid diphenyl ester, phenylphosphonic acid diethyl ester, triphenylphosphinic oxide or tricresylphosphinic oxide. Triphenyl phosphate is particularly preferred. Another preferred phosphorus compound is bisphenol-A-bisphenyl-diphosphate.

Said phosphorus compounds are known (cf. for example EP-A 363 608, EP-A 640 655) or may be prepared in a manner similar to known methods (for example Ullmanns Encyklopädie der technischen Chemie, vol. 18, pp 301 ff. 1979; Houben-Weyl, Methoden der organischen Chemie, vol. 12/1, p. 43; Beilstein vol. 6, p. 177).

The polyolefin compound included as component C) is a polyolefin wax, preferably a polypropylene or polyethylene wax; polyethylene waxes are particularly preferred. The term “polyolefin wax” refers in general to polyolefins with a wax-like character. Such compounds may be obtained by methods known to persons skilled in the art, either by direct polymerisation of olefinic basic monomers or controlled depolymerisation from polymers of correspondingly high molar masses, and normally have low molar masses (approx. 3,000-20,000 g/mol). The polyolefin compound is used in quantities of 0.05 to 1.5% by weight, preferably 0.1 to 0.7% and particularly preferably from 0.15 to 0.45%. Mixtures of different polyolefins may similarly be used.

If zinc sulphide is used as component D) it is included in quantities preferably of 0.1 to 4% by weight and particularly preferably 0.4 to 3.5% relative to the entire molding composition. The use of 0.4 to 1.0% by weight of ZnS is very particularly preferred in certain embodiments of the invention. The zinc sulphide is generally used as a particulate solid. Some examples of commercially available products are Sachtolith® HDS or Sachtolith® HD (both produced by Sachtleben, Duisburg, Germany). Use of compacted material and of master batches in a polymeric supporting material is likewise possible. The zinc sulphide may be surface treated and/or coated with known media. These include inter alia organic compounds, which may be applied in monomeric, oligomeric and/or polymeric form. Coatings with inorganic components are also possible.

For example, coating systems based on silicon-containing compounds such as organo-functionalised silanes, aminosilanes or organosiloxanes may be used.

The molding composition further contains 0 to 50% by weight, preferably 10 to 40% and particularly 10 to 35% of filler and reinforcing materials, which are added as component E).

The fillers and reinforcing materials in the form of fibers or particles which may be added to form the molding compositions of the invention include inter alia glass fibers, glass beads, glass cloth, glass mats, carbon fibers, aramid fibers, potassium titanate fibers, natural fibers, amorphous silicic acid, magnesium carbonate, barium sulphate, feldspar, mica, silicates, quartz, talc, kaolin, titanium dioxide and wollastonite; these may also be surface treated. The preferred reinforcing materials are commercial glass fibers. These are generally between 8 and 18 μm in diameter and may be added in the form of fibers or cut or ground ones. The fibers may be provided with an appropriate sizing system and a bonding agent or bonding system based for example on silane.

Acicular mineral fillers are also appropriate. In the invention, an acicular mineral filler is understood as being a mineral filler with a very pronounced needle-shaped character. Acicular wollastonite may be given as an example. The mineral preferably has an L/D (length/diameter) ratio of 8:1 to 35:1, more preferably 8:1 to 11:1. The mineral filler may optionally be surface treated.

Component F

Additional use of rubber-elastic polymers (often described as impact modifiers, elastomers or rubber) may in many cases prove advantageous for the mechanical properties.

Generally speaking these are copolymers, preferably made up of at least two of the following monomers: ethylene, propylene, butadiene, isobutene, isoprene, chloroprene, vinylacetate, styrene, acrylonitrile and acrylic or methacrylic acid ester with 1 to 18 carbon atoms in the alcohol component.

Polymers of this type are described for example in Houben-Weyl, Methoden der organischen Chemie, vol. 14/1 (Georg-Thieme-Verlag, Stuttgart, 1961), pages 392 to 406 and in C. B. Bucknall's study “Toughened Plastics” (Applied Science Publishers, London, 1977).

Rubber-elastic polymers as described in WO 00/46419 are preferred.

The polyesters according to the invention may also contain other additives, such as means to prevent decomposition or cross-linking caused by heat or damage by ultraviolet light, plasticisers, flow promoters, processing aids, flame-retarding substances, lubricants and demolding agents, nucleating agents, antistatic agents, stabilizers and dyestuffs and pigments. ZnS is excluded as component F.

Some examples of oxidation retarding agents and heat stabilizers are sterically hindered phenols and/or phosphites, hydroquinones, aromatic secondary amines such as diphenyl amines, various substituted representatives of these groups and mixtures thereof.

The UV stabilizers may be various substituted resorcinols, salicylates, benzotriazoles and benzophenones.

Inorganic pigments may be added, such as titanium dioxide, ultramarine blue, iron oxide and soot, also organic pigments such as phthalocyanines, quinacridones, perylenes and dyestuffs such as nigrosine and anthraquinones as colouring agents, and other colouring agents.

Nucleating agents which may be used are for example sodium phenyl phosphinate, aluminium oxide, silicon dioxide and preferably talc.

Other, preferably halogen-free phosphorus compounds which are not specially mentioned here may be used alone or combined in any way with other, preferably halogen-free phosphorus compounds. These also include purely inorganic phosphorus compounds such as boron phosphate hydrate or elementary, preferably red phosphorus.

The lubricants and demolding agents generally used are ester waxes, pentaerithryte tetrastearate (PETS), long-chain fatty acids (for example stearic or behenic acid), salts thereof (for example Ca or Zn stearate) and amide derivatives (for example ethylene-bis-stearylamide) or montan waxes (mixtures of straight-chain, saturated carboxylic acids with chain lengths of 28 to 32 carbon atoms.

Some examples of plasticisers are phthalic acid dioctylester, phthalic acid di-benzylester, phthalic acid butylbenzylester, hydrocarbon oils and N-(n-butyl)benzene sulphonamide.

The invention will be further explained below with reference to some concrete examples.

### EXAMPLES

| | |
|---|---|
| Component A/1 | PBT Pocan ® B 1300 00/000 |
| | (Bayer AG, Leverkusen, Germany) |
| Component A/2 | PBT Pocan ® B 1600 (Bayer AG, Leverkusen, |
| | Germany) |
| Component A/3 | PET R10 (Agfa, Mortsel, Belgium) |
| Component B.1 | Melamine cyanurate |
| | (Melapur ® MC 25, DSM-Melapur, Mortsel, |
| | Belgium) |
| Component B.2 | Triphenyl phosphate |
| | (Disflamoll ® TP, Bayer AG, Leverkusen, Germany) |
| Component C | Polyolefin wax Luwax ® A |
| | (BASF AG, Ludwigshafen, Germany) |
| Component D | ZnS (Sachtolith ® HDS, Sachtleben, Duisburg, |
| | Germany) |
| Component E | Chopped glass strands |
| | (CS 7962, Bayer AG, Leverkusen, Germany) |
| Component F1 | Microtalc RP-6 (Bayer AG, Leverkusen, Germany) |
| Additive F2 | Montan glycol wax |
| | (E-wax, Hoechst, Frankfurt a.M., Germany) |
| Additive F3 | Stabilizer 10% concentrate in Pocan B 1300 00/000 |

The individual components are mixed in the given ratios in a twin screw extruder, model ZSK 32, produced by Werner & Pfleiderer at temperatures of 260° C., extruded as a strand and pelletised after cooling to the necessary temperature. When the granules have been dried, they are processed at temperatures of 260° C. to form standard test pieces from which the mechanical, electrical and burning properties are ascertained.

The flame resistance of plastics is determined by the UL94V method (see a) Underwriters Laboratories Inc. Standard of Safety, “Test for flammability of plastic materials for parts in devices and appliances”, pp. 14 ff., Northbrook 1998; b) J. Troitzsch, “International Plastics Flammability Handbook”, pp. 346 ff., Hanser Verlag, Munich 1990). These assess the burning times and dripping action of ASTM standard test pieces.

For a flame-retardant plastic to obtain a UL94V flammability rating it has to fulfil the following criteria: in a set of 5 ASTM standard test pieces (dimensions: 127×12.7×X, with X=3.2; 1,6 and 0.8 mm), none of the specimens must burn for longer than 10 seconds after an open flame of defined height has been applied to them twice, for 10 seconds each time. The sum of the burning times when a flame has been applied 10 times to 5 specimens must not be longer than 50 seconds. In addition each respective specimen must not drip burning material, must not burn away completely and must not have an afterglow time longer than 30 seconds. For a UL94V-1 flammability rating, the individual burning times must not be longer than 30 seconds and the sum of the burning times after a flame has been applied 10 times to 5 samples must not be longer than 250 seconds. The total afterglow time must not be more than 250 seconds. The other criteria are the same as those mentioned above. A UL94V-2 flammability rating is obtained if the test pieces drip burning material but the other UL94V-1 criteria are fulfilled.

The mechanical properties of the polymer compositions are determined by the ISO 527 tensile test (with dumbbell test pieces), the ISO 178 bending test (with flat test pieces 80 mm×10 mm×4 mm) and the Izod flexural impact test (ISO 180, with flat test pieces 80 mm×10 mm×4 mm).

TABLE 1

| | Comparison | Comparison | Example | Example | Example |
|---|---|---|---|---|---|
| Component | 1 | 2 | 1 | 2 | 3 |
| A/1 | 28.7 | 28.2 | 28.7 | 27.7 | 9.7 |
| A/2 | — | — | — | — | 17.0 |
| A/3 | 20.0 | 20.0 | 20.0 | 20.0 | 20.0 |
| B.1 | 10.0 | 10.0 | 10.0 | 10.0 | 10.0 |
| B.2 | 10.0 | 10.0 | 10.0 | 10.0 | 11.0 |
| C | — | — | 0.3 | 0.3 | 0.3 |
| D | — | — | — | 1.0 | 1.0 |
| Additive F2 | 0.3 | 0.3 | — | — | — |
| Additive F3* | 1.0 | 1.0 | 1.0 | 1.0 | 1.0 |
| E | 30.0 | 30.0 | 30.0 | 30.0 | 30.0 |
| F1 | — | 0.5 | — | — | — |
| UL 94 (1.6 mm) | n.s. | n.s. | V-2 | V-2 | V-2 |
| IZOD impact strength | 32 kJ/m² | 36 kJ/m² | 44 kJ/m² | 49 kJ/m² | 48 kJ/m² |
| (ISO 180/1U 23° C.) | | | | | |
| Outer fiber elongation at | 2.81% | 3.32% | 3.66% | 3.89% | 3.94% |
| flexural strength | | | | | |

n.s. = not successful
*10% concentrate in POCAN B 1300 00/000

The test results shown in the above table prove that the molding compositions according to the invention have good impact strength and outer fiber elongation as well as the desired flame resistance, whereas comparative examples 1 and 2 have inadequate flame resistance and also considerably poorer mechanical characteristics.

The mechanical properties of the molding compositions according to the invention (Example 1) may be further raised by adding ZnS (see Examples 2 and 3).

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A thermoplastic molding composition comprising:
A) one or more polymeric resin selected from the group consisting of (co)polyester, polyestercarbonate and (co)polycarbonate,
B) 10 to 40%, relative to the total weight of the composition, of a flame retardant component containing a nitrogen compound B.1) and a phosphorus compound B.2) of formula (I) 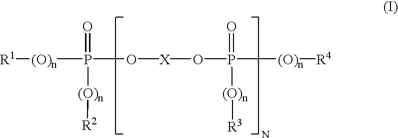
where
R¹, R², R³ and R⁴ each represent, independently of one another, C₁ to C₈ alkyl, C₅ to C₆ cycloalkyl, C₆ to C₂₀ aryl or C₇ to C₁₂ aralkyl,
n independently one of the others is 0 or 1,
m is 0 to 50 and
X is a C₆₋₃₀-aromatic radical with single or multiple rings,
C) 0.05 to 1.5% relative to the total weight of the composition of polyolefin wax,
D) 0 to 5% relative to the total weight of the composition of zinc sulphide,
E) 0 to 50% relative to the total weight of the composition of one or more fillers and reinforcing agents and
F) is 0 to 40% relative to the total weight of the composition of further additives,
the sum of the weights of the components making up 100% by weight.

2. The molding composition according to claim 1, wherein component A) is a polyalkylene terephthalate.

3. The molding composition according to claim 1, wherein component A) is selected from the group consisting of polyethylene terephthalate and poly-butylene terephthalate.

4. The molding composition according to claim 1 wherein the content of component B) is 15 to 26%.

5. The molding composition according to claim 1 wherein the content of nitrogen compound B.1) is 7 to 13%.

6. The molding composition according to claim 1 wherein the content of B.2) is 8 to 13%.

7. The molding composition according to claim 1 wherein the content of polyolefin wax is 0.1 to 0.7%.

8. The molding composition according to claim 1 wherein the content of zinc sulphide is 0.1 to 4%.

9. The molding composition according to claim 1 wherein B.1) is melamine cyanurate.

10. The molding composition according tom claim 1 wherein B.2) is triphenyl phosphate.

11. The molding composition according to claim 1 wherein B.2) is bisphenol-A-bisdiphenyl phosphate.

12. The molding composition according to claim 1 wherein further additives refer to at least one member selected from the group consisting of stabilizers against decomposition, thermal stabilizers, ultraviolet light stabilizers, plasticizers, flow promoters, processing aids, flame-retarding agents differing from B), lubricants and de-molding agents, nucleating agents, antistatic agents, dyestuffs and pigments.

13. The molding composition according to claim 1 wherein the reinforcing agent is glass fibers.

14. A method of using the molding composition of claim 1 comprising producing a molded article.

15. A molded article comprising the composition of claim 1.

16. A fiber comprising the composition of claim 1.
